(19) United States
(12) Patent Application Publication
(10) Pub. No.: US 2009/0064530 A1
(43) Pub. Date: Mar. 12, 2009

(54) Clothes treatment apparatus

(75) Inventors: Jung Wook Moon, Changwon-si (KR); Dae Yun Park, Changwon-si (KR); Sog Kie Hong, Changwon-si (KR); Jong Seok Kim, Changwon-si (KR); Seung Gyu Ryu, Changwon-si (KR); Kwang Hee Lee, Changwon-si (KR); Hye Yong Park, Changwon-si (KR); Chang Gyu Choi, Changwon-si (KR); Dong Won Kim, Changwon-si (KR)

Correspondence Address: MCKENNA LONG & ALDRIDGE LLP, 1900 K STREET, NW, WASHINGTON, DC, 20006, US

(73) Assignee: LG ELECTRONICS INC., Seoul (KR)

(21) Appl. No.: 12/219,950

(22) Filed: Jul. 30, 2008

(30) Foreign Application Priority Data
Aug. 3, 2007 (KR) 10-2007-0078171
Mar. 12, 2008 (KR) 10-2008-0022717

(51) Int. Cl. F26B 25/06; G10K 11/00

(52) U.S. Cl. 34/232; 181/196

(57) ABSTRACT

A clothes treatment apparatus that treats clothes into a condition suitable to wear is disclosed. The clothes treatment apparatus includes a cabinet, a receiving space defined in the cabinet for receiving clothes, air and moisture supply devices for supplying dried air and moisture into the receiving space, respectively, an outfit chamber defined in the cabinet for receiving the hot air and steam supply devices, the outfit chamber including an inlet port for allowing external air to be introduced into the outfit chamber therethrough to cool the hot air and steam supply devices, and a noise prevention device installed at the inlet port for preventing noise generated in the outfit chamber from being discharged out of the outfit chamber through the inlet port.

### CROSS-REFERENCE TO RELATED APPLICATION

This application claims the benefit of Korean Patent Application No. 10-2007-0078171, filed on Aug. 3, 2007, Korean Patent Application No. 10-2008-0022717, filed on Mar. 12, 2008 which is hereby incorporated by reference in its entirety as if fully set forth herein.

### BACKGROUND OF THE INVENTION

1. Field of the Invention

The present invention relates to a clothes treatment apparatus, and more particularly, to a clothes treatment apparatus that is capable of reducing noise generated from an outfit chamber where various kinds of devices are installed.

1. Discussion of the Related Art

Generally, a clothes treatment apparatus is an apparatus that treats clothes into better conditions. In recent years, there has been popularized a clothes treatment apparatus that is capable of performing various refresh functions, such as removal of wrinkles, smells, and/or static electricity from clothes.

Such a clothes treatment apparatus includes an additional outfit chamber for receiving various kinds of devices that provide the above-described functions. However, some of the devices installed in the outfit chamber generate high-temperature heat, which may reduce the life spans of the other devices and parts installed in the outfit chamber. For this reason, the outfit chamber is provided at one side thereof with an inlet port, through which air is introduced into the outfit chamber. The air introduced through the inlet port is used to cool the devices installed in the outfit chamber.

However, the inlet port is open, with the result that noise generated from the various kinds of devices installed in the outfit chamber is discharged out of the outfit chamber through the inlet port. Also, external dust is introduced into the outfit chamber through the inlet port. During the operation of the clothes treatment apparatus, therefore, the clothes treatment apparatus is very noisy, and the various kinds of devices in the outfit chamber of the clothes treatment apparatus may break down due to dust introduced into the outfit chamber.

### SUMMARY OF THE INVENTION

Accordingly, the present invention is directed to a clothes treatment apparatus that substantially obviates one or more problems due to limitations and disadvantages of the related art.

An object of the present invention is to provide a clothes treatment apparatus that is capable of reducing noise generated during the operation of the clothes treatment apparatus.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a clothes treatment apparatus includes a cabinet, a receiving space defined in the cabinet for receiving clothes, air and moisture supply devices for supplying dried air and moisture into the receiving space, respectively, an outfit chamber defined in the cabinet for receiving the hot air and steam supply devices, the outfit chamber including an inlet port for allowing external air to be introduced into the outfit chamber therethrough to cool the hot air and steam supply devices, and a noise prevention device installed at the inlet port for preventing noise generated in the outfit chamber from being discharged out of the outfit chamber through the inlet port.

In an embodiment, the noise prevention device includes a hollow pipe extending inwardly or outwardly of the outfit chamber from the inlet port, and the hollow pipe is disposed while being inclined upward.

More specifically, the hollow pipe includes a first end directly connected to the inlet port and a second end formed at the side opposite to the first end, the second end being disposed higher than the first end.

In another embodiment, the noise prevention device includes a plurality of flow channels disposed in the inlet port while being connected to each other. Preferably, the flow channels are defined in a wall of the cabinet, the flow channels communicate with the outfit chamber and the outside of the clothes treatment apparatus, respectively. Also, the flow channels are disposed in a zigzag fashion, with the result that the flow channels are constructed in a labyrinth structure.

More specifically, the noise prevention device includes a first flow channel extending in a first direction and a second flow channel extending from the first flow channel in a second direction opposite to the first direction.

Preferably, the outfit chamber further includes an auxiliary inlet port formed at the bottom of the outfit chamber for allowing external air to be introduced into the outfit chamber therethrough. The auxiliary inlet port is disposed adjacent to a suction side of a blowing fan. Also, the auxiliary inlet port is smaller than the inlet port.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a front view illustrating a clothes treatment apparatus according to the present invention;

FIG. 2 is a front view partially illustrating the internal structure of the clothes treatment apparatus shown in FIG. 1;

FIG. 3 is a perspective view illustrating an outfit chamber of the clothes treatment apparatus shown in FIG. 1; and

FIGS. 4 and 5 are sectional views respectively illustrating noise prevention devices installed in an inlet port of the clothes treatment apparatus shown in FIG. 1.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

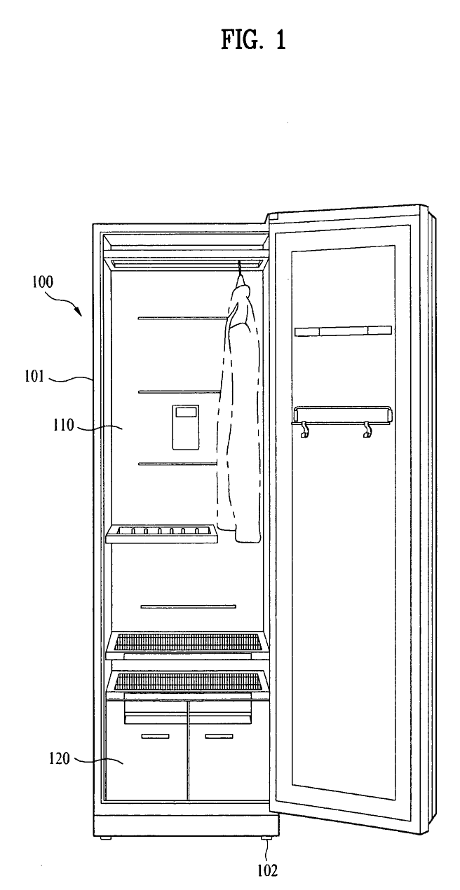

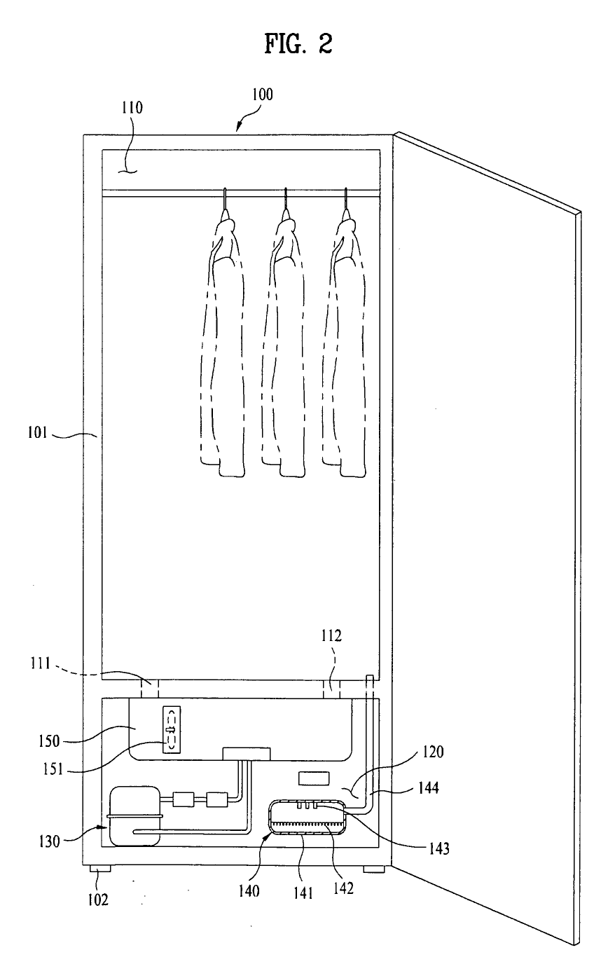

FIG. 1 is a front view illustrating a clothes treatment apparatus according to the present invention, and FIG. 2 is a front view illustrating the interior of an outfit chamber of the clothes treatment apparatus shown in FIG. 1.

As shown in FIGS. 1 and 2, a clothes treatment apparatus 100 according to the present invention includes a cabinet 101 basically forming the overall external appearance of the clothes treatment apparatus. In the cabinet 101, at the upper side of the cabinet, a receiving space 110 for receiving clothes is defined. Actually, an inner cabinet is provided at the upper portion in the cabinet 101 of the clothes treatment apparatus, and the receiving space 110 is defined in the inner cabinet. Such an inner cabinet is fixed to the cabinet 101, and thus is stationary. In the cabinet 101, at the lower side of the cabinet, an outfit chamber 120, in which various kinds of devices necessary to treat the clothes received in the receiving space 110, is defined. Also, legs 102 are mounted to the bottom of the cabinet 101 for supporting the clothes treatment apparatus 100.

Referring to FIG. 2, an air supply device 130, for supplying dried and hot air necessary to dry the clothes received in the receiving space 110, is installed in the outfit chamber 120. FIG. 2 illustrates the air supply device 130 using a heat pump. The heat pump generates the heated and dried using a kind of refrigeration cycle and supplies the generated heated and dried air into the receiving space 110. Of course, an electric heater or various different devices may be used as the air supply device 130.

In the outfit chamber 120 is installed a supply duct 150 for supplying the dried air generated by the air supply device 130 into the receiving space 110. An entrance 111 is formed at one side of the bottom defining the receiving space 110, and an exit 112 is formed at the other side of the bottom, such that the hot and dried air supplied from the air supply device 130 is introduced into the receiving space 110 and is then circulated. Also, the entrance 111 and the exit 112 are connected to one side and the other side of the supply duct 150, respectively. In addition, a circulation fan 151, for circulating hot and dried air, is installed in the duct 150.

In the outfit chamber 120 is also installed a moisture supply device 140 for generating moisture and provide generated moisture to the receiving space 110. The moisture supply device 140 could use a mist which comprises fine droplets of water in a liquid phase or a steam which is a vapor phase of water, to moisturizing the receiving space 110. The present application describes the moisture supply device 140 using the steam in the followings. However, the moisture supply device 140 using the mist could be applied to the clothes treatment apparatus for the same purpose. A steam supply pipe 144 is connected between the moisture supply device 140 and the receiving space 110 such that the steam generated by the moisture supply device 140 is guided into the receiving space 110.

The moisture supply device 140 for generating steam includes a case 141 for storing water, a heater 142 installed in the case 141, and a water level sensor 143 for sensing the water level in the case 141. The moisture supply device 140 may be constructed either in a water pipe connection structure in which the moisture supply device 140 is directly connected to a water supply source for supplying water such that the water is supplied to the moisture supply device 140 or in a cartridge structure in which a user supplies a predetermined amount of water into the case 141.

As previously described, the dried air and the steam are supplied into the receiving space 110 by the air supply device 130 and the moisture supply device 140. Such dried and hot air and steam remove wrinkles, smells, and/or static electricity from clothes. Consequently, the clothes can be refreshed into a condition optimal to immediately wear by the clothes treatment apparatus 100. However, the air supply device 130 and the moisture supply device 140 generate a large amount of heat, and therefore, it is necessary to reduce such heat in order to prevent the breakdown or deformation of the other devices installed in the receiving space.

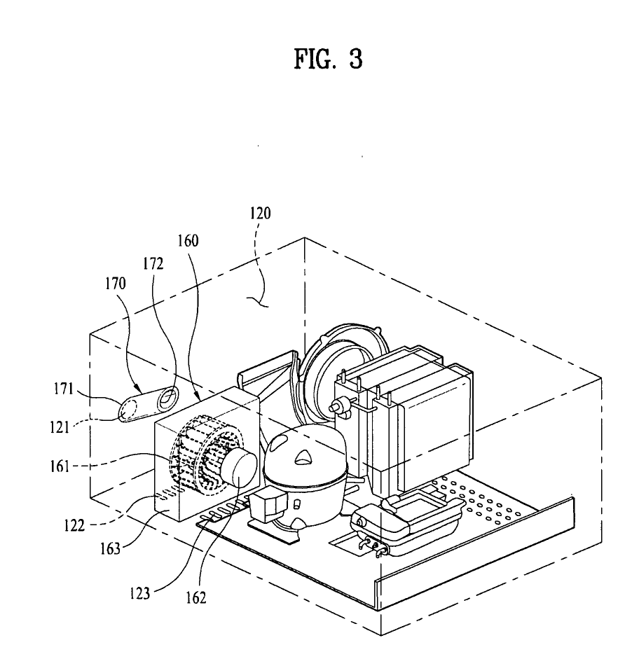

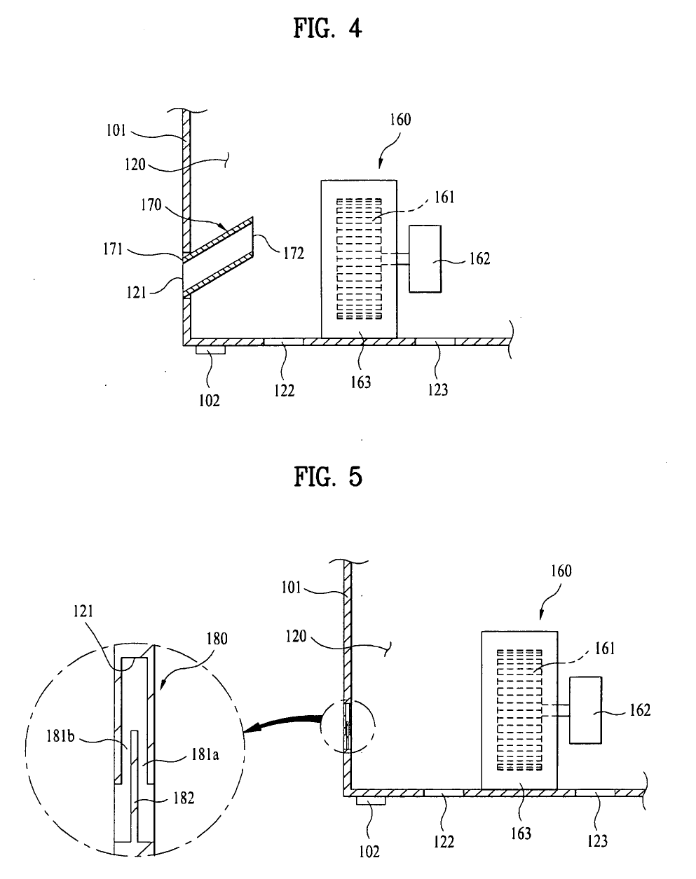

FIG. 3 is a perspective view illustrating the interior of the outfit chamber 120, and FIG. 4 is a sectional view of FIG. 3.

As shown in FIG. 3, an inlet port 121 is formed at one side of the outfit chamber 120, exactly at the sidewall of the cabinet 101, such that air necessary to reduce heat generated in the outfit chamber 120 is introduced into the outfit chamber 120 through the inlet port 121. Also, a blower 160 for generating a suction force necessary to introduce air through the inlet port 121 is mounted in the outfit chamber 120 such that the blower 160 is spaced a predetermined distance from the inlet port 121.

The blower 160 includes a blowing fan 161, a drive motor 162 for providing a drive force to the blowing fan 161, and a fan housing 163 for guiding the flow direction of air discharged from the blowing fan 161 while surrounding the blowing fan 161.

However, not only the blower 160 but also other devices 130 and 140 generate great noise during the operation of the clothes treatment apparatus 100, and this noise may be discharged out of the clothes treatment apparatus 100 through the inlet port 121. For this reason, the clothes treatment apparatus 100 further includes a noise prevention device for allowing air to be introduced into the outfit chamber 120 through the inlet port 121 but preventing noise generated in the outfit chamber 120 from being discharged out of the outfit chamber 120.

As shown in FIG. 4, the noise prevention device may include a hollow pipe 170 extending from the inlet port 121 in an inclined structure. The hollow pipe 10 may extend inwardly or outwardly of the outfit chamber 120; however, it is preferred for the hollow pipe 10 to be installed such that the hollow pipe 10 extends inwardly of the outfit chamber 120 in consideration of the pleasing appearance of the clothes treatment apparatus and the spatial utilization of the outfit chamber. In particular, it is preferred for the hollow pipe 170 to be installed such that the hollow pipe 170 extends while being inclined toward the upper side of the outfit chamber 120. The hollow pipe 170 includes a first end 171 directly connected to the inlet port 121 and a second end 172 formed at the side opposite to the first end 171. The hollow pipe 170 is preferably disposed such that the second end 172 is higher than the first end 171. That is, the hollow pipe 170 is disposed such that the hollow pipe 170 can be inclined upward, as previously described, by the arrangement of the first and second ends 171 and 17.

As the hollow pipe 170 is disposed while being inclined upward, the hollow pipe 170 allows external air to be introduced into the outfit chamber 120 but acts as an obstacle with respect to noise generated from the air supply device 130, the moisture supply device 140, and the blower 160, installed in the outfit chamber 120. Consequently, the hollow pipe 170 reduces noise discharged out of the outfit chamber 120.

Also, when air containing dust is introduced into the outfit chamber 120 through the hollow pipe 170, the dust is separated from the air by the friction between the dust and the inner surface of the hollow pipe 170. In addition, the dust, separated from the air, slips out of the outfit chamber 120 along the hollow pipe 170, with the result that the dust is prevented from being introduced into the outfit chamber 120.

Meanwhile, since the noise prevention device is installed at the inlet port 121, the blower 160 cannot be directly connected to the inlet port 121. Consequently, the blower 160 is installed while being spaced a predetermined distance from the inlet port 121, through which air is introduced into the outfit chamber 120. The fan housing 163 of the blower 160 is fixed to the bottom of the outfit chamber 120.

FIG. 5 illustrates another noise prevention device that performs a similar function.

As shown in FIG. 5, the noise prevention device includes a plurality of flow channels 180 disposed in the inlet port 121 while being connected to each other. The flow channels 180 are defined in the wall of the cabinet 101. The flow channels 180 communicate with the outfit chamber 120 and the outside of the clothes treatment apparatus 100, respectively, such that the basic function of the inlet port 121 is achieved, i.e., external air is introduced into the outfit chamber 120 through the inlet port 121. More specifically, the noise prevention device includes a first flow channel 181a extending in a first direction and a second flow channel 181b extending from the first flow channel 181a in a second direction opposite to the first direction. The first and second directions may be upward and downward directions, respectively, as shown in FIG. 5, and vice versa. Also, the first and second direction may be opposite horizontal directions. As previously described, the first and second flow channels 181a and 181b are disposed in a zigzag fashion, and a partition 181 is disposed in the inlet port 121 to separate the first and second flow channels 181a and 181b from each other. As a result, the flow channels 180 are constructed in a labyrinth structure.

Air outside the outfit chamber 120 may be suctioned into the outfit chamber 120 through the flow channels 180 by the blowing force generated from the blower 160. As the flow channels 180 very lengthily extend due to the labyrinth structure, however, the noise generated in the outfit chamber 120 may be greatly reduced while the noise passes through the flow channels 180.

Meanwhile, as shown in FIGS. 3 to 5, auxiliary inlet ports 122 and 123 are further formed at the bottom of the outfit chamber 120 such that external air can be introduced into the outfit chamber through the auxiliary inlet ports 122 and 123, in addition to the inlet port 121. As previously described, the bottom of the outfit chamber 120, i.e., the bottom of the cabinet 101, is spaced a predetermined distance from the floor by the legs 102. Consequently, external air can be smoothly introduced into the outfit chamber 120 through the auxiliary inlet ports 122 and 123.

The auxiliary inlet ports 122 and 123 may be disposed adjacent to the blower 160 for smooth introduction of external air. Also, since the blower 160 is installed adjacent to the inlet port 121, as previously described, the auxiliary inlet ports 122 and 123 are disposed adjacent to the inlet port 121.

The auxiliary inlet ports may include a first auxiliary inlet port 122 formed at the suction side of the blower 160 and a second auxiliary inlet port 123 formed at the discharge side of the blower 160. The amount of air suctioned is greatly increased by the auxiliary inlet ports 122 and 123 located at different positions. However, the amount, the velocity, and the pressure of air at the discharge side of the blower 160 are very large. Consequently, the air introduced through the second auxiliary inlet port 123 may collide with the air discharged from the blower 160, with the result that great noise may be generated. For this reason, it is preferred to provide the outfit chamber 120 with only the first auxiliary inlet port 122 in order to restrain the generation of noise.

Each of the auxiliary inlet ports 122 and 123 may include a plurality of small-sized slots arranged side by side. The plurality of small-sized slots are more effective to prevent noise generated in the outfit chamber 120 out of the clothes treatment apparatus therethrough than a one single large-sized hole. In the same manner, the inlet port 121 may include a plurality of slots. Also, since the blower 160 mainly suctions external air through the inlet port 121, the inlet port 121 has a size greater than that of the auxiliary inlet ports 122 and 123.

Since the inlet port 121 is formed at the sidewall of the outfit chamber 120, whereas the auxiliary inlet ports 122 and 123 are formed at the bottom of the outfit chamber 120, the flow direction of air introduced through the auxiliary inlet ports 122 and 123 is perpendicular to the flow direction of air introduced through the inlet port 121. That is, external air is introduced into the outfit chamber 120 simultaneously in two different directions. Consequently, the amounts of air passing through the respective inlet ports 121, 122, and 123 are greatly reduced as compared with when external air is introduced through only a single inlet port. For this reason, pressures generated at the respective inlet ports 121, 122, and 123 are reduced, and therefore, noise generated from air when the air passes through the respective inlet ports 121, 122, and 123 is also reduced.

Also, in the structure in which the single inlet port is used, great noise is generated, and the introduction of air into the outfit chamber 120 is not smoothly achieved, when the inlet port is clogged by foreign matter. In the structure in which the plurality of inlet ports 121, 122, and 123 are used as previously described, on the other hand, air can be smoothly introduced through the remaining inlet ports, although one of the inlet ports is clogged.

As apparent from the above description, the clothes treatment apparatus according to the present invention has the effect of reducing noise generated during the operation of the clothes treatment apparatus.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A clothes treatment apparatus comprising:
a cabinet;
a receiving space defined in the cabinet for receiving clothes;
air and moisture supply devices for supplying dried air and moisture into the receiving space, respectively;
an outfit chamber defined in the cabinet for receiving the hot air and steam supply devices, the outfit chamber including an inlet port for allowing external air to be introduced into the outfit chamber therethrough to cool the hot air and steam supply devices; and
a noise prevention device installed at the inlet port for preventing noise generated in the outfit chamber from being discharged out of the outfit chamber through the inlet port.

2. The clothes treatment apparatus according to claim 1, wherein the noise prevention device includes a hollow pipe extending inwardly or outwardly of the outfit chamber from the inlet port.

3. The clothes treatment apparatus according to claim 2, wherein the hollow pipe is disposed in an inclined structure.

4. The clothes treatment apparatus according to claim 2, wherein the hollow pipe is inclined upward.

5. The clothes treatment apparatus according to claim 2, wherein the hollow pipe includes a first end directly connected to the inlet port and a second end formed at the side opposite to the first end, the second end being disposed higher than the first end.

6. The clothes treatment apparatus according to claim 1, wherein the noise prevention device includes a plurality of flow channels disposed in the inlet port while being connected to each other.

7. The clothes treatment apparatus according to claim 6, wherein the flow channels are defined in a wall of the cabinet.

8. The clothes treatment apparatus according to claim 6, wherein the flow channels communicate with the outfit chamber and the outside of the clothes treatment apparatus, respectively.

9. The clothes treatment apparatus according to claim 6, wherein the flow channels are constructed in a labyrinth structure.

10. The clothes treatment apparatus according to claim 1, wherein the flow channels are disposed in a zigzag fashion.

11. The clothes treatment apparatus according to claim 6, wherein the noise prevention device includes a first flow channel extending in a first direction and a second flow channel extending from the first flow channel in a second direction opposite to the first direction.

12. The clothes treatment apparatus according to claim 10, wherein the first direction is an upward direction, and the second direction is a downward direction.

13. The clothes treatment apparatus according to claim 9, wherein the noise prevention device includes a plurality of the first and second flow channels.

14. The clothes treatment apparatus according to claim 1, wherein the inlet port is disposed in the outfit chamber such that the inlet port is adjacent to a blower for generating a blowing force necessary to suction air.

15. The clothes treatment apparatus according to claim 1, wherein the inlet port is formed at a sidewall of the outfit chamber.

16. The clothes treatment apparatus according to claim 1, wherein the outfit chamber further includes an auxiliary inlet port formed at the bottom of the outfit chamber for allowing external air to be introduced into the outfit chamber therethrough.

17. The clothes treatment apparatus according to claim 16, wherein the auxiliary inlet port is disposed adjacent to a blowing fan for suctioning air.

18. The clothes treatment apparatus according to claim 16, wherein the auxiliary inlet port is disposed adjacent to a suction side of a blowing fan.

19. The clothes treatment apparatus according to claim 16, wherein the auxiliary inlet port is smaller than the inlet port.

20. The clothes treatment apparatus according to claim 16, wherein the auxiliary inlet port includes a plurality of slots.
